(19) United States
(12) Patent Application Publication
(10) Pub. No.: US 2010/0107682 A1
(43) Pub. Date: May 6, 2010

(54) Line Set

(76) Inventor: Kent Cartheuser, Cincinnati, OH (US)

Correspondence Address: JAY M. SCHLOFF, 6960 Orchard Lake Road, Suite 315, West Bloomfield, MI, 48322, US

(21) Appl. No.: 12/611,259

(22) Filed: Nov. 3, 2009

Related U.S. Application Data
(60) Provisional application No. 61/111,541, filed on Nov. 5, 2008.

(51) Int. Cl. F25B 1/00; F16L 25/00; F25D 23/00; B32B 1/08

(52) U.S. Cl. 62/498; 285/334.5; 428/603

(57) ABSTRACT

A line set for a heat regulating system for circulating a refrigerant. The line set may include a first tubing member made of at least one of aluminum and aluminum alloys. The first tubing member may include a first end capable of engaging with a first service port of an evaporator assembly and a second end capable of engaging with a second service port of a compressor assembly. The line set may include a second tubing member made of at least one of aluminum and aluminum alloys. The second tubing member may include a first end portion capable of engaging with a third service port of a condenser assembly and a second end portion capable of engaging with a fourth service port of an evaporator assembly. The first tubing member and the second tubing member may be configured to circulate the refrigerant in the heat regulating system.

### CROSS REFERENCE TO RELATED APPLICATION

This application claims the benefit of U.S. Provisional Application No. 61/111,541 filed on Nov. 5, 2008, the disclosure of which is incorporated by reference.

### FIELD OF THE DISCLOSURE

The present disclosure generally relates to tubing members of heat regulating systems, and, more specifically, to a line set that is flexible, lightweight and economical.

### BACKGROUND OF THE DISCLOSURE

Heat regulating systems, such as air conditioning systems, refrigeration systems, and the like, are based on evaporation and condensation of a material typically called a refrigerant. The heating regulating systems require a plurality of tubing members to transfer the refrigerant in and throughout various components of the heat regulating system. Typically, the plurality of tubing members is made of copper and copper alloys.

However, copper is a dense metal with a density of about 8.92 grams per cubic centimeter, which makes the plurality of tubing members bulky and cumbersome to manage. Further, in recent years the cost of copper has increased exponentially, which in turn has increased the cost of the heat regulating systems.

### SUMMARY OF THE DISCLOSURE

The present disclosure provides, in one embodiment, a line set for a heat regulating system for circulating a refrigerant. The heat regulating system may have an evaporator assembly, a compressor assembly, a discharge line and a condenser assembly. The line set may include a first tubing member made of at least one of aluminum and aluminum alloys. The first tubing member may include a first end capable of engaging with a first service port of the evaporator assembly and a second end capable of engaging with a second service port of the compressor assembly. The first tubing member may be configured to fluidically communicate the evaporator assembly with the compressor assembly. Further, the line set may include a second tubing member made of at least one of aluminum and aluminum alloys. The second tubing member may include a first end portion capable of engaging with a third service port of the condenser assembly and a second end portion capable of engaging with a fourth service port of the evaporator assembly. The second tubing member may be configured to fluidically communicate the condenser assembly with the evaporator assembly. The first tubing member and the second tubing member may be configured to circulate the refrigerant in the heat regulating system.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of an embodiment of a line set; and

FIG. 2 illustrates a block diagram of an exemplary air conditioning system with the line set of FIG. 1.

Like reference numerals refer to like parts throughout the description of several views of the drawings.

### DETAILED DESCRIPTION OF THE DISCLOSURE

The exemplary embodiments described herein provide detail for illustrative purposes and are subject to many variations in structure and design. It should be emphasized, however, that the present disclosure is not limited to a particular line set, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a line set that may be easily incorporated into a multitude of heat regulating systems including, but not limited to, air conditioning systems, heating systems, refrigeration systems, and the like. However, for the sake of brevity, the present disclosure has been illustrated as configured in an air conditioning system, and the same should not be construed as limiting the present disclosure.

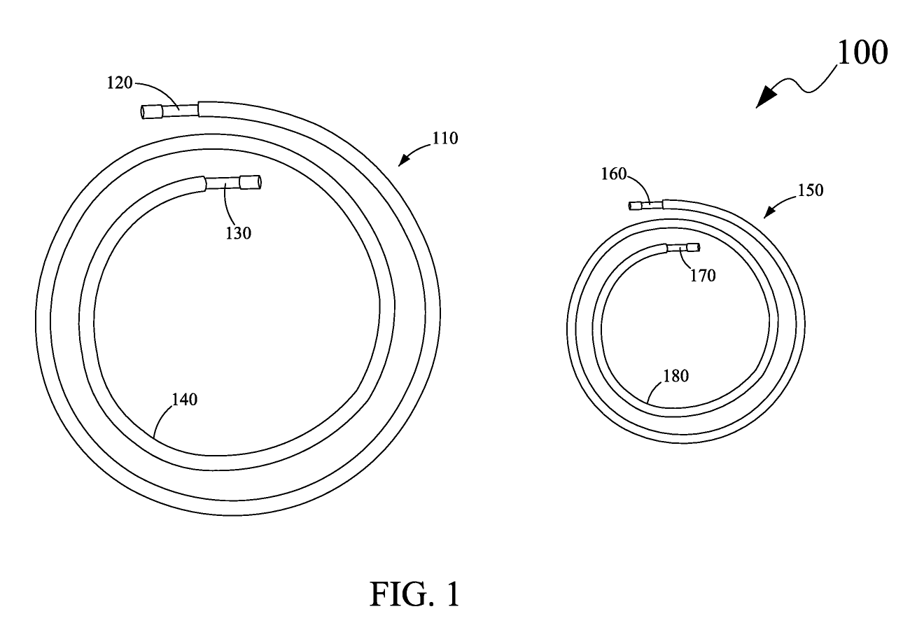

Referring to FIG. 1, one embodiment of a line set 100 is shown, that may be configured to a heat regulating system (not shown), such as an air conditioning system for circulating a refrigerant (not shown).

Referring to FIG. 1, the line set 100 may include a first tubing member 110 having a first end 120 and a second end 130. The first tubing member 110 may be made of aluminum and aluminum alloys, for example, 3003 of 3000 series of aluminum alloys, 6061 of 6000 series of aluminum alloys, 1100 series of aluminum alloys, and combinations thereof. The first tubing member 110 may be partially insulated or completely insulated by a first insulated covering 140. The first tubing member 110 may be of different sizes and shapes. For example, the first tubing member 110 may have a wall thickness ranging from about 0.0015 inches to about 0.093 inches, length ranging from about 5 feet to about 100 feet, outer diameter ranging from about ¼ inch to about 1.5 inches, inner diameter ranging from about 2 feet to about 5 feet and a height ranging from about 1 inch to about 48 inches. Further, the first tubing member 110 may be tempered at all temperatures, and preferably, at a soft temper, such as ‘O’ temper. Furthermore, a wall thickness of the first insulated covering 140 may range from about ¼ inches to 2 inches. A service temperature for the first insulated covering 140 may range from about 0 degrees Fahrenheit to about 220 degrees Fahrenheit. Also, the first insulated covering 140 may be composed of a material that may be resistant to ultraviolet (UV) rays.

Referring to FIG. 1, the line set 100 may further include a second tubing member 150 having a first end portion 160 and a second end portion 170. The second tubing member 150 may be made of aluminum and aluminum alloys, for example, 3003 of 3000 series of aluminum alloys, 6061 of 6000 series of aluminum alloys, 1100 series of aluminum alloys, and combinations thereof. The second tubing member 150 may be partially insulated or completely insulated by a second insulated covering 180. The second tubing member 150 may be of different sizes and shapes. For example, the second tubing member 150 may have a wall thickness ranging from about 0.0015 inches to about 0.093 inches, length ranging from about 5 feet to about 100 feet, outer diameter ranging from about ¼ inch to about 1.5 inches, inner diameter ranging from about 2 feet to about 5 feet and a height ranging from about 1 inch to about 48 inches. Further, the second tubing member 150 may be tempered at all temperatures, and preferably, at a soft temper, such as ‘O’ temper. Furthermore, a wall thickness of the second insulated covering 180 may range from about ¼ inch to 2 inches. A service temperature for the second insulated covering 180 may range from about minus 0 degrees Fahrenheit to about 220 degrees Fahrenheit. Also, the second insulated covering 180 may be composed of a material that may be resistant to ultraviolet (UV) rays.

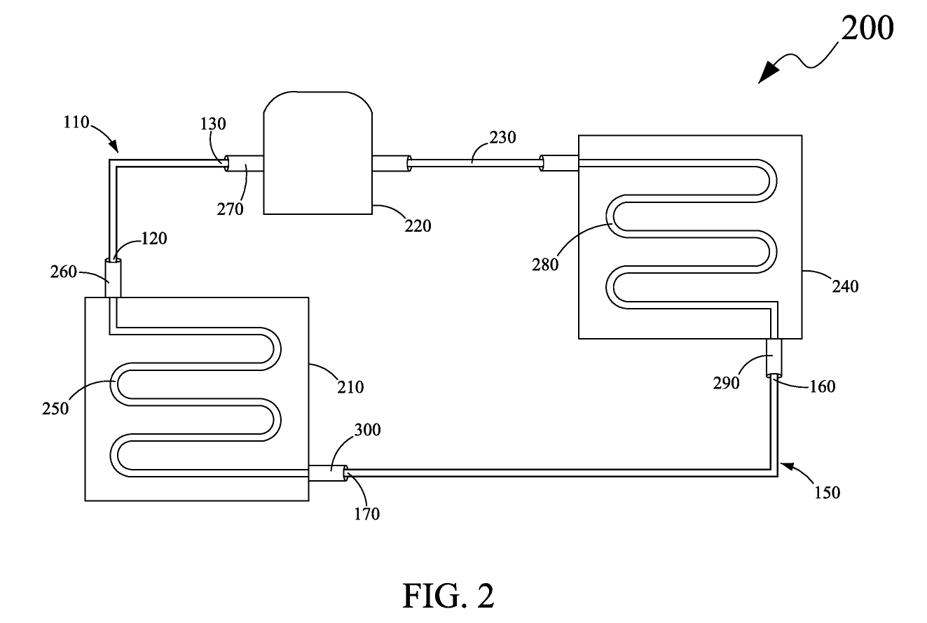

FIG. 2 illustrates the line set 100 incorporated in an exemplary air conditioning system 200 (hereinafter referred to as ‘system 200’). The system 200 may include an evaporator assembly 210, a compressor assembly 220, a discharge line 230 and a condenser assembly 240. However, it will be apparent that the above mentioned components are basic components of the system 200, and, other components exist in the system 200 that have not been illustrated for the sake of brevity. The evaporator assembly 210 may include an evaporator coil 250 through which the refrigerant flows. The first tubing member 110 may be configured to fluidically communicate the evaporator assembly 210 with the compressor assembly 220. For example, the evaporator assembly 210 may be capable of engaging the first end 120 of the first tubing member 110 through a first service port 260. The first tubing member 110 may be configured to carry the refrigerant from the evaporator coil 250 into the compressor assembly 220. The second end 130 of the first tubing member 110 may be carried by the compressor assembly 220 through a second service port 270. The compressor assembly 220 may be configured to compress the refrigerant. The compressor assembly 220 may be carried by the condenser assembly 240 through the discharge line 230. The compressed refrigerant may flow from the compressor assembly 220 to the condenser assembly 240 through the discharge line 230.

The condenser assembly 240 may include a condenser coil 280 through which the compressed refrigerant flows. The second tubing member 150 may be configured to fluidically communicate the condenser assembly 240 with the evaporator assembly 210. For example, the condenser assembly 240 may be capable of engaging the first end portion 160 of the second tubing member 150 through a third service port 290. The second end portion 170 of the second tubing member 150 may be carried by the evaporator assembly 210 through a fourth service port 300. The refrigerant flows through a closed path from the evaporator assembly 210 through the compressor assembly 220 to the condenser assembly 240 and back to the evaporator assembly 210. The refrigerant undergoes change in state from a liquid state to a vapor state and back to the liquid state while flowing through the closed path.

Further, during installation of the system 200, the line set 100 may be carried by the components of the system 200 through at least one of soldering and brazing, by using at least one of solder or braze alloy. A transition tubing connection may be formed between the first end 120 and a copper alloy tubing (not shown) capable of allowing the coupling of the first end 120 with the first service port 260 of the evaporator assembly 210, and the second end 130 and a copper alloy tubing (not shown) capable of allowing the coupling of the second end 130 with the second service port 270 of the compressor assembly 220 with at least one of a soldering and brazing by using at least one of solder or braze alloy. Similarly, a transition tubing connection may be formed between the first end portion 160 and a copper alloy tubing (not shown) capable of allowing the coupling of the first end portion 160 with the third service port 290 of the condenser assembly 240, and the second end portion 170 and a copper alloy tubing (not shown) capable of allowing the coupling of the second end portion 170 with the fourth service port 300 of the evaporator assembly 210 with at least one of a soldering and brazing by using at least one of solder or braze alloy. The copper alloy in the copper alloy tubing may be composed of about 99% to about 99.99% of Cu and about 0.001% to about 0.95% of Phosphorous. In an embodiment of the present disclosure, the copper alloy tubing of the first tubing member 110 may have specific dimensions for length, outer and inner diameters, wall thickness, and other parameters. For example, the first tubing member 110 configured with the copper alloy tubing may have wall thickness ranging from about 0.0015 inches to about 0.093 inches, length ranging from about ¼ inch to about 48 inches and outer diameter ranging from about ¼ inch to about 1.5 inches. The copper alloy of the copper alloy tubing may be tempered at all temperatures, and preferably, at an annealed or dead soft temper.

Further, the at least one of solder and braze alloy may be made of different compositions of materials. For example, in an embodiment of the present disclosure, the at least one of braze and solder alloy may be made by combining about 0.01% to about 99.9% of tin with about 0.01% to about 99.9% of zinc. In another embodiment of the present disclosure, the at least one of braze and solder alloy may be made by combining about 0.01% to about 99.9% of tin with about 0.01% to about 99.9% of cadmium. In still another embodiment of the present disclosure, the at least one of braze and solder alloy may be made by combining about 0.01% to about 99.9% of aluminum with about 0.01% to about 99.9% of zinc. In yet another embodiment of the present disclosure, the at least one of braze and solder alloy may be made by combining about 0.01% to about 99.9% of aluminum with about 0.01% to about 99.9% of silicon. In yet another embodiment of the present disclosure, the transition tubing connection may be formed by using American Welding Society (AWS) standard alloy A5.8 BCuP 5 composed of 15% silver (Ag), 80% copper and 5% phosphorous. A working temperature of the AWS standard alloy may be about 1485 degrees Fahrenheit and a melting temperature of the AWS standard alloy ranges from about 850 degrees Fahrenheit to about 1080 degrees Fahrenheit.

Alternatively, the first end 120 and the second end 130 of the first tubing member 110 may be flared or expanded to fluidically communicate the first tubing member 110 with the evaporator assembly 210 and the compressor assembly 220. Also, the first end 120 and the second end 130 may be bent at an angle of about 45 degrees or about 90 degrees. Further, the first end 120 and the second end 130 may include a flare nut member (not shown) for coupling the first service port 260 and the second service port 270, respectively.

Similarly, the first end portion 160 and the second end portion 170 of the second tubing member 150 may be flared or expanded to fluidically communicate the second tubing member 150 with the condenser assembly 240 and the evaporator assembly 210. Also, the first end portion 160 and the second end portion 170 may be bent at an angle of about 45 degrees or about 90 degrees. Further, the first end portion 160 and the second end portion 170 may include a flare nut member (not shown) for coupling the third service port 290 and the fourth service port 300, respectively.

The line set 100 as implemented by a heat regulating system, such as the system 200, of the present disclosure is advantageous as it may reduce the weight associated with a conventional line set by up to 70%, thereby making the line set easily manageable by a person installing the heat regulating system. Further, the line set of the present disclosure utilizes aluminum and aluminum alloys as material of construction, thereby reducing a manufacturing cost of the line set, which in turn reduces overall cost of the heat regulating system.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. A line set for a heat regulating system for circulating a refrigerant, the heat regulating system having an evaporator assembly, a compressor assembly, a discharge line and a condenser assembly, the line set comprising:
a first tubing member made of at least one of aluminum and aluminum alloys, the first tubing member comprising a first end capable of engaging with a first service port of the evaporator assembly and a second end capable of engaging with a second service port of the compressor assembly, the first tubing member configured to fluidically communicate the evaporator assembly with the compressor assembly; and
a second tubing member made of at least one of aluminum and aluminum alloys, the second tubing member comprising a first end portion capable of engaging with a third service port of the condenser assembly and a second end portion capable of engaging with a fourth service port of the evaporator assembly, the second tubing member configured to fluidically communicate the condenser assembly with the evaporator assembly,
wherein the first tubing member and the second tubing member is configured to circulate the refrigerant in the heat regulating system.

2. The line set of claim 1, wherein the first end and the second end of the first tubing member is flared to fluidically communicate the first tubing member with the evaporator assembly and the compressor assembly.

3. The line set of claim 2, wherein the flared first end and the flared second end comprises a flare nut member.

4. The line set of claim 1, wherein a transition tubing connection is formed between the first end and a copper alloy tubing capable of allowing the coupling of the first end with the first service port of the evaporator assembly, and the second end and a copper alloy tubing capable of allowing the coupling of the second end with the second service port of the compressor assembly with at least one of a soldering and brazing by using at least one of solder or braze alloy.

5. The line set of claim 4, wherein the at least one of solder and braze alloy is composed of about 0.01% to about 99.99% of tin and about 0.1% to about 99.9% of zinc.

6. The line set of claim 4, wherein the at least one of solder and braze alloy is composed of about 0.01% to about 99.99% of tin and about 0.1% to about 99.9% of cadmium.

7. The line set of claim 4, wherein the at least one of solder and braze alloy is composed of about 0.01% to about 99.99% of aluminum and about 0.1% to about 99.9% of zinc.

8. The line set of claim 4, wherein the at least one of solder and braze alloy is composed of about 0.01% to about 99.99% of aluminum and about 0.1% to about 99.9% of silicon.

9. The line set of claim 1, wherein the first end portion and the second end portion of the second tubing member is flared to fluidically communicate the second tubing member with condenser assembly and the evaporator assembly.

10. The line set of claim 9, wherein the flared first end portion and the flared second end portion comprises a flare nut member.

11. The line set of claim 1, wherein a transition tubing connection is formed between the first end portion and a copper alloy tubing capable of allowing the coupling of the first end portion with the third service port of the condenser assembly, and the second end portion and a copper alloy member capable of allowing the coupling of the second end portion with the fourth service port of the evaporator assembly with at least one of a soldering and brazing by using at least one of solder or braze alloy.

12. The line set of claim 11, wherein the at least one of solder and braze alloy is composed of about 0.01% to about 99.99% of tin and about 0.1% to about 99.9% of zinc.

13. The line set of claim 11, wherein the at least one of solder and braze alloy is composed of about 0.01% to about 99.99% of tin and about 0.1% to about 99.9% of cadmium.

14. The line set of claim 11, wherein the at least one of solder and braze alloy is composed of about 0.01% to about 99.99% of aluminum and about 0.1% to about 99.9% of zinc.

15. The line set of claim 11, wherein the at least one of solder and braze alloy is composed of about 0.01% to about 99.99% of aluminum and about 0.1% to about 99.9% of silicon.

16. The line set of claim 1, wherein the first tubing member is covered with a first insulated covering.

17. The line set of claim 1, wherein the second tubing member is covered with a second insulated covering.
